(19) United States
(12) Patent Application Publication
(10) Pub. No.: US 2012/0176592 A1
(43) Pub. Date: Jul. 12, 2012

(54) OPTICAL SENSOR

(75) Inventors: Horst Essig, Kirchheim/Teck (DE); Fabian Geiger, Leinfelden-Echterdingen (DE); Dieter Klass, Frickenhausen (DE); Juergen-Ralf Weber, Ebersbach (DE)

(73) Assignee: Leuze Electronic GmbH & Co.KG, Owen/Teck (DE)

(21) Appl. No.: 13/497,709

(22) PCT Filed: Aug. 14, 2010
(86) PCT No.: PCT/EP2010/005005

§ 371 Date: Mar. 22, 2012

(30) Foreign Application Priority Data
Sep. 29, 2009 (EP) 09 012 302.7

(51) Int. Cl. G01C 3/00

(52) U.S. Cl. 356/3.01

(57) ABSTRACT

A method for optically detecting objects includes emitting light rays that are projected as a light line onto an object structure to be detected. The light rays are imaged on a matrix of receiving elements of a receiver to produce receiving element signals. The receiving element signals are evaluated by a triangulation principle to generate a distance profile. The evaluating includes: generating at least one evaluation window which encompasses a local range extending in a direction along the light line, generating a number of object points representing outputs of the respective receiving element that correspond to respective distances extending in a second direction, and generating a binary state information as a function of the number object points that fall within the evaluation window.

### CROSS-REFERENCE TO RELATED APPLICATIONS

This application is a U.S. National Stage application of International Application No. PCT/EP2009 filed Sep. 29, 2010, designating the United States and claiming priority to European Patent Application EP 09 012 302.7 filed Sep. 29, 2009,

### BACKGROUND OF THE INVENTION

The invention relates to an optical sensor.

Optical sensors of the type discussed herein are used in particular for the parallel detection of several objects. One example for this is the detection of a number of objects, conveyed in several tracks on a conveyor belt. For the simultaneous detection of these objects, the number of conveying tracks typically corresponds to the number of optical sensors which can be used to detect respectively one object at certain points, meaning locally on one track. Optical sensors of this type can be embodied as light scanners which respectively comprise a transmitter for emitting a light ray having an essentially point-shaped cross section. To be sure, the individual sensors can be produced easily and cost-effectively. However, the costs increase rather quickly if a plurality of individual sensors is required. A further disadvantage is that if the respective application is changed, all individual sensors must be adjusted and parameterized again, which results in considerable time expenditure.

European patent document EP 0 892 280 B1 discloses an active light source and a light-receiving unit in the form of a line-type or matrix-type CCD array. The light receiving unit is divided into several receiving zones which respectively correspond to an object zone in a monitored area. Contrast differences are detected in each receiving zone for the object detection.

### SUMMARY OF THE INVENTION

It is an object of the present invention to provide an optical sensor with expanded function.

The above and other objects are accomplished according to the invention wherein there is provided, in one embodiment, an optical sensor for use with a transmitting unit that emits light rays projected as a light line onto an object structure to be detected, comprising; a receiver including a matrix of receiving elements, wherein the light line is imaged on the receiving elements to generate signals; and an evaluation unit coupled to receive the signals from the receiving elements to evaluate the signals by a triangulation principle to generate a distance profile, wherein the evaluation unit generates at least one evaluation window which encompasses a local range extending in a direction along the light line and a number of object points representing outputs of the respective receiving element that correspond to respective distances extending in a second direction, and wherein the evaluation unit generates a binary state information as a function of the number object points that fall within the evaluation window.

As a result of the line shape of the light rays emitted by the transmitter, an extended area can be monitored with the optical sensor according to the invention, wherein it is advantageous that no movable parts are required for deflecting the light rays. Instead, the transmitter generates a constant light line on an object structure to be examined. Several objects can thus be detected simultaneously with the aid of the sensor according to the invention.

Distance information relating to objects to be detected may be obtained with the aid of a distance measurement realized with the triangulation principle. As a result, it is possible to detect objects spatially resolved, wherein contour information of objects in particular can be obtained.

As a result of defining one or more evaluation windows, as disclosed for the invention, different objects or object structures can purposely be acquired in these windows. The evaluation windows here represent specific segments of the monitoring area, wherein each evaluation window furthermore covers a defined distance range. By specifying this distance range, the spatial resolution during the object acquisition can be specified purposely in the respective evaluation window, thus making it possible, for example, to acquire objects purposely in front of background structures.

By generating a binary state information for each evaluation window, a statement is obtained for each evaluation window, indicating whether or not an expected object structure or an expected object is detected. On the one hand, this evaluation results in a secure and precise detection of an object. On the other hand, the generating of the binary state information from a plurality of object points results in a data reduction, so that the evaluation requires only a low amount of computing time.

According to an embodiment, the evaluation of the object points in an evaluation window is limited to a pure counting operation which can be carried out easily and quickly.

For the evaluation of object points within an evaluation window, the binary state information may assume a first state “1” whenever the number of object points within the evaluation window is higher than a switch-on number and the binary state information may assume a second state “0” if the number of object points within the evaluation window is lower than a switch-off number.

The switch-on number and the switch-off number in this case represent adjustable parameters. By selecting these parameters, it is easy to realize an application-specific adaptation of the evaluation of the object points within an evaluation window With a suitable selection of the switch-on number and the switch-off number, so that the switch-on number is higher than the switch-off number, a switching hysteresis can be generated during the switching between the states “0” and “1,” thereby resulting in a secure switching behavior between the states.

According to an embodiment, the number of positions and the dimensioning of the evaluation windows can be parameterized.

By specifying the evaluation windows, the optical sensor can thus be adapted easily and quickly to different applications. The number of object points within an evaluation window can furthermore be specified by suitably dimensioning the evaluation windows. An improvement in the detection sensitivity is thus obtained since the adjustment may result in an increased tolerance toward mirror-reflections, shadings, or contrast errors. This parameterization is usefully realized with the aid of a learning mode, prior to the operation of the optical sensor.

According to another embodiment, a follow-up of the positions of the evaluation windows can take place, in particular with respect to a specific reference position, so that the parameters of the optical sensor can be adapted to changing boundary conditions, even during the operation.

In the simplest case, the binary state information from the evaluation windows takes the form of output variables.

Alternatively, a logical linking of binary state information from individual evaluation windows for generating output variables can also be realized in the evaluation unit.

Detailed statements relating to complex object structures can thus be provided when generating output variables in this way. Different individual structures of objects can be assigned to individual evaluation windows, wherein precise information relating to individual structures can be obtained quickly and easily as a result of the evaluation in the individual evaluation windows. The information concerning the total structure can then be inferred quickly and easily, based on the logical linking of the binary state information from the evaluation windows.

In the simplest case, the evaluation of object points within an evaluation window is realized in such a way that the number of object points within the evaluation window is selected independent of their relative positions.

Alternatively, only successively following object points within an evaluation window are evaluated for determining the contours of objects. Thus, only contours of objects are purposely viewed when using this additional limitation for the evaluation within one evaluation window.

Binary state information for the individual evaluation windows and thus for the corresponding output variables can in principle be generated immediately for both variants, for each measurement realized with the optical sensor, meaning the images recorded in the receiver.

Several successively following measurements can also be used with a different alternative for generating binary state information for an evaluation window.

To be sure, using several measurements for generating binary state information and output variables will reduce the switching frequency of the optical transmitter, meaning its reaction time. However, this also increases the detection security of the optical sensor.

In general, measuring value fluctuations within at least one evaluation window can be detected and, depending thereon, an error message or a warning message can be generated.

The error and warning messages generated in this way indicate at what point the individual output variables from the optical sensor no longer have the required reliability.

The evaluation of the optical sensor in principle can be expanded to include not only distance information, but also object contrast information. For this, reflectance values for the individual object points are determined as additional information by evaluating the amplitude of the signals received at the receiving elements.

In an embodiment, the exposure to light that is realized with the transmitter may be controlled or regulated only in dependence on the signals received at the receiving elements and located within the evaluation window or windows.

The adaptation of the exposure thus always purposely occurs in dependence on the imaging components of the optical sensor which are selected by the evaluation window and are of interest to the object detection.

### BRIEF DESCRIPTION OF THE DRAWINGS

The invention is explained in the following with the aid of the drawings, which show in:

FIG. 1: A schematic representation of an exemplary embodiment of the optical sensor according to the invention;

FIG. 2: A view of the top of the receiver for the optical sensor according to FIG. 1;

FIG. 3: A first variant showing a defined evaluation window for an object detection with the optical sensor according to FIG. 1;

FIG. 4: A second variant showing a defined evaluation window for an object detection with the optical sensor according to FIG. 1;

FIG. 5: The defining of evaluation windows according to the invention for a container, using the optical sensor as shown in FIG. 1.

### DETAILED DESCRIPTION

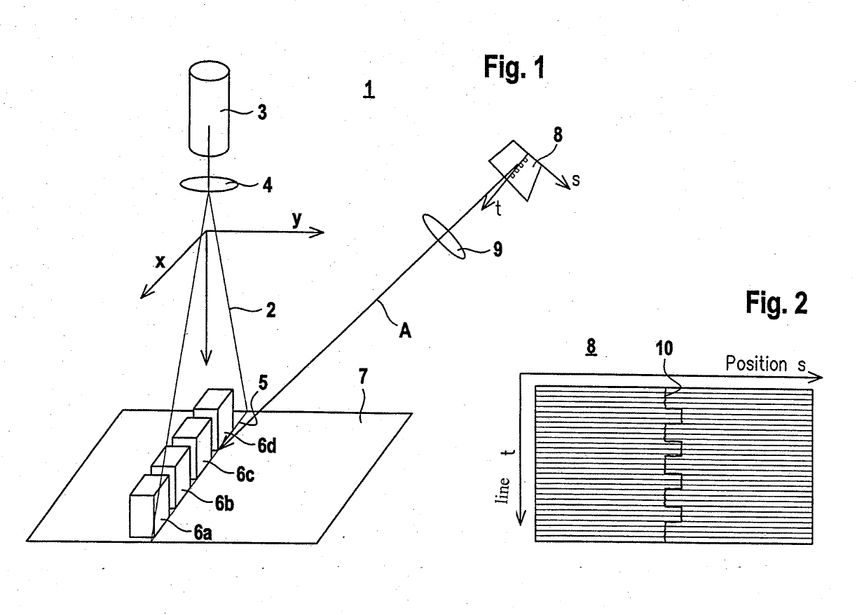

FIG. 1 schematically depicts an embodiment of the optical sensor 1 according to the invention. The optical sensor 1 is a light section sensor which can be used for realizing distance measurements based on the triangulation principle, thereby permitting a position-sensitive detection of an object in an area to be monitored.

The optical sensor 1 comprises a transmitting unit with a transmitter 3 for emitting light rays 2 and a downstream-arranged transmitting optics 4. The transmitter 3 for the present case may be a laser and in particular a laser diode. The laser emits a bundled laser beam with an approximately circular beam cross section. The transmitting optics 4, which are embodied as expansion optics, functions to generate the light rays 2 that sweep the area to be monitored. With the aid of the transmitting optics 4, the laser beam is reshaped into light rays 2 with a line-shaped cross section, so that a light line 5 is generated on the surface of an object structure to be detected.

Several objects can be detected simultaneously with a light line 5 embodied in this way. For the embodiment shown in FIG. 1, these are the objects 6a-6d which are arranged in four separate tracks and are conveyed on a conveying belt 7, wherein this conveying belt 7 conveys the objects in the y direction. The objects 6a-6d are arranged side-by-side and spaced apart in the x direction. Accordingly, the light line 5 of the optical sensor 1 also extends in the x direction, so that the objects 6a-6d can be detected simultaneously by the light rays 2.

The optical sensor 1 furthermore comprises a receiver 8 with spatial resolution and a matrix-type array of receiving elements, meaning an arrangement divided into lines and columns. The receiver 8 may be composed of a CMOS or a CCD array. The receiver 8 is furthermore assigned receiving optics 9 which image the light rays 2, reflected back by object structures, on the receiver 8.

The receiver 8 is arranged at a distance to the transmitter 3. In addition, the optical axis A of the receiver 8 is inclined at an angle, relative to the beam axis for the laser beam which extends the z direction. In FIG. 1, the line direction of the receiver 8 is given the reference t and the column direction is given the reference s. The line direction t extends at least approximately in the x direction.

The optical sensor 1, for which the components are integrated into a housing that is not shown herein is furthermore provided with an evaluation unit, also not shown herein, in the form of a microprocessor or the like. The evaluation unit functions on the one hand to trigger the transmitter 3 and, on the other hand, to evaluate the signals received at the receiving elements of the receiver 8.

Distance profiles of object structures can be determined with the optical sensor 1 embodied in this way. This is illustrated with the aid of FIG. 2 which shows a view from above of the receiver 8 for the optical sensor 1. The light line 5 conducted onto an object structure is imaged with spatial resolution on the receiver 8. This is illustrated in FIG. 2 in the form of a contour line 10 which corresponds to the object structure in FIG. 1, consisting of four objects 6a-6d on the conveying belt 7. For this, the positions in column direction s define the respective height values. If the receiver 8 position is known, relative to the transmitter 3, then the contour line 10 is converted to a distance profile, meaning to individual height values z in dependence on the position x in longitudinal direction of the light line 5.

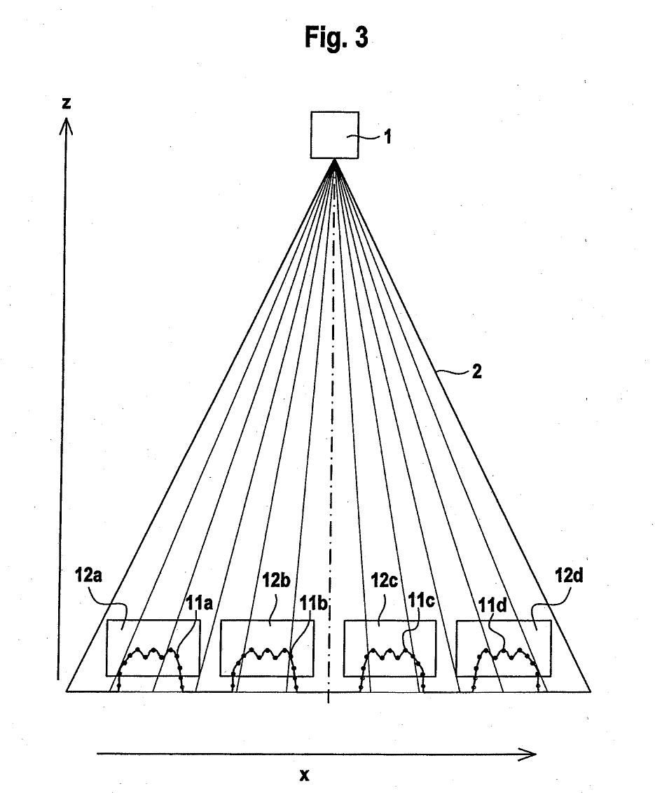

FIG. 3 schematically shows the discrete sequences of height line measuring values, determined in this way for the four objects 6a-6d, meaning the measuring values 11a-11d for the four objects 6a-6d on the conveying belt 7. The measuring values in-between come from the conveying belt 7. For the illustration, the region of the optical sensor 1 which is detected by the light rays 2 is additionally drawn into the diagram.

Four different evaluation windows 12a-12d are defined in the evaluation unit of the optical sensor 1 for the selective detection of the objects 6a-6d on the conveying belt 7, as shown in FIG. 3. The evaluation windows 12a-12d encompass a respectively defined local range in x direction and a defined distance range in z direction. An evaluation window 12a-12d is here defined for each object 6a-6d to be detected, wherein the position and size of this window is adapted to the size of the respective object 6a-6d to be detected. In the present case, four objects 6a-6d of approximately equal size are conveyed in four spaced-apart tracks, side-by-side on the conveying belt 7. Since the objects 6a-6d are illuminated at an angle from above by the light rays 2 coming from the transmitter 3, the two objects 6a, 6b that are arranged on the left side are shaded slightly along the left edge while the two objects 6c, 6d arranged on the right side are shaded slightly along the respective right edge. As a result, the distributions of the measuring values 11a-11d are not completely identical. Nevertheless, the measuring values to be expected for the detection of the individual objects 6a-6d coincide approximately, so that identically embodied evaluation windows 12a-12d are defined for the detection of all four objects 6a-6d, wherein these windows are spaced apart uniformly as shown in FIG. 3.

For the detection of an object 6a-6d, the number of object points in the associated evaluation window 12a-12d are counted, meaning the number of measuring values 11a-11d which fall within in the evaluation window 12a-12d. An object point of this type is an output signal from a receiving element of the receiver 8 which is located within the evaluation windows 12a-12d following the conversion to z-x coordinates, with respect to the position and distance value. This number is compared to a switch-on number and a switch-off number, thereby generating binary state information. If the number of object points is higher than the switch-on number, the binary state information assumes the state “1” which corresponds in the present case to the “object detected” state. If the number of object points is lower than the switch-off number, the binary state information assumes the state “0” which in the present case corresponds to the “object not detected” state. A switching hysteresis is usefully defined by selecting the switch-on number to be higher than the switch-off number. For example, if the binary state information is in the state “1,” it does not immediately change to the state “0” if the number of object points drops below the switch-on number. Rather, the number of object points must drop below the switch-off number for this to occur. The same is true for the reverse change in the state.

For the situation illustrated in FIG. 3, an object 6a-6d is detected in all four evaluation windows 12a-12d. The respective information bits relating to the state can be issued directly in the form of output variables via outputs or bus interfaces. Alternatively, the binary state information bits can also be logically linked to form one or several output variables.

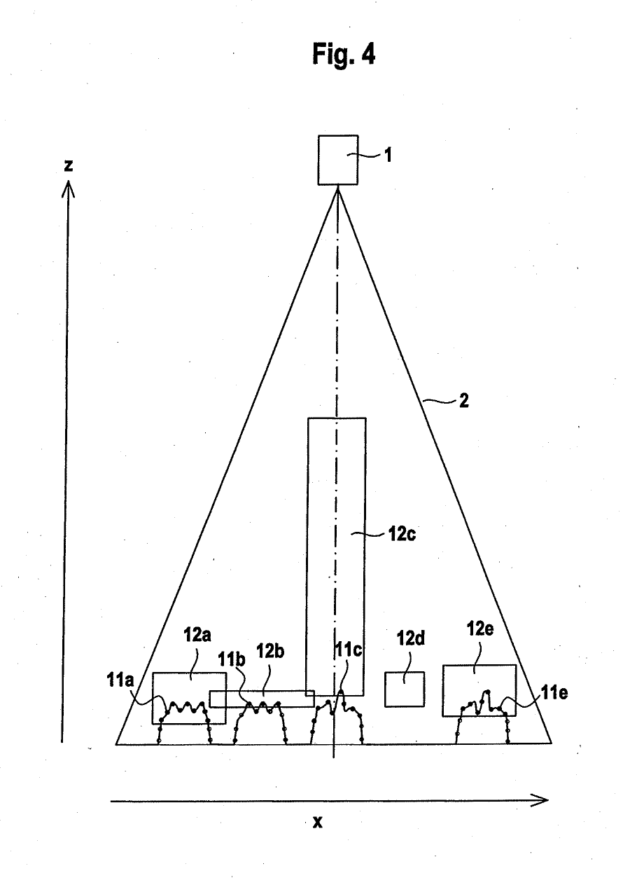

The optical sensor 1 according to the invention can be adapted quickly and easily to changing application conditions. FIG. 4 shows the adaptation to such a change in application. In place of the four objects 6a-6d, five objects (not shown in detail herein) are conveyed for this application in five side-by-side arranged tracks on the conveying belt 7. For this, the objects located in the center track can vary considerably in height while the object in the second track from the left has a greater width as compared to the other objects.

The adaptation to the changed application is realized through a change in the positions and dimensions of the evaluation windows 12a-12e and, if applicable, the respective switch-on number and/or the switch-off number for the evaluation windows 12a-12e. FIG. 4 shows the changed evaluation windows 12a-12e. Corresponding to the changed measuring task, namely the detection of five objects, five evaluation windows 12a-12e are now defined. The changed evaluation windows 12a-12e are shown in FIG. 4. According to the expected size differences for the objects in the center track, the evaluation window 12c extends over a longer distance range Z. Since additional objects can be arranged in the second track, the associated evaluation window 12b is expanded further in the x direction, so that it overlaps with the adjacent evaluation windows 12a, c.

As can be seen in FIG. 4, measuring values are recorded for objects in the first three and the fifth track. However, the corresponding measuring values 11b, 11c for the objects in the second and third tracks are still mostly outside of the respective evaluation window 12b, 12c, so that the respective number of object points obtained from this evaluation window fall below the switch-off number. The evaluation windows 12b, 12c thus signal the binary state information “object not detected” in the same way as the evaluation window 12d where no object points were recorded. In contrast, the binary state information “object detected” is obtained for the evaluation windows 12a, 12e.

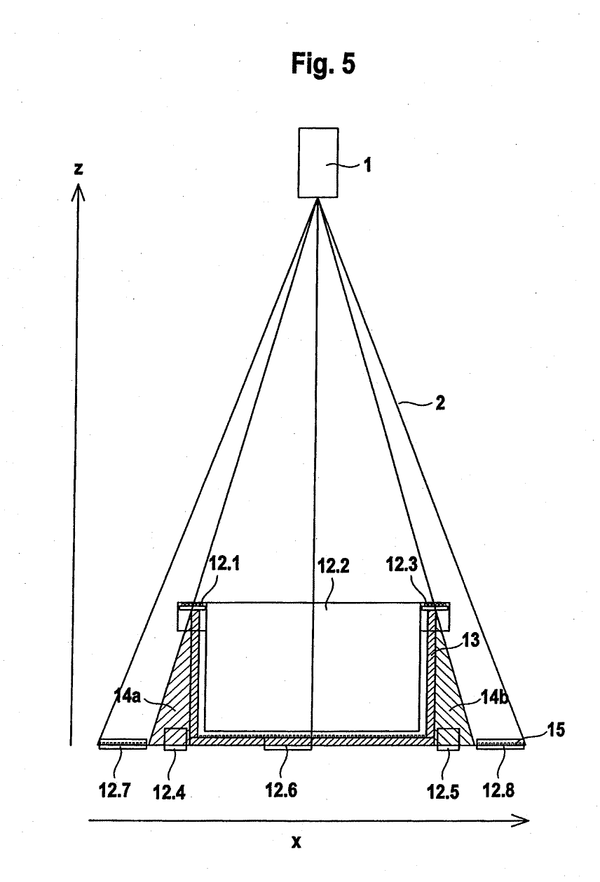

FIG. 5 shows a different example for using the optical sensor 1. In this case, a container 13 and if applicable also the container filling are to be detected with the optical sensor 1. For this, the evaluation windows 12.1 and 12.3 are preferably defined which are adapted to the expected top edges of the container. In addition, an evaluation window 12.2 is defined for the container inside space.

A container 13 is considered detected if in both evaluation windows 12.1 and 12.3 the number of object points is respectively higher than the switch-on number, meaning if the logic link requirement is met that the binary state information of the evaluation window 12.1 and also the binary state information for the evaluation window 12.3 is in the state “1” which means “object detected.” In that case, the output variable “container detected” is generated.

The output variable “container full” is furthermore generated if the evaluation window 12.2 is in the state “1,” meaning “object detected.”

The evaluation can be improved further if additional evaluation windows 12.4 and 12.5 are defined for the regions 14a, 14b that are shaded by the container 13.

In that case, it is necessary that following an AND operation, the binary state information=“1” is present for the evaluation windows 12.1 and 12.3 and that the binary state information=“0” is present for the evaluation windows 12.4 and 12.5.

The evaluation can furthermore be expanded by introducing an evaluation window 12.6 for checking the container bottom. This evaluation window 12.6 can also be used to determine the existence of the container 13, wherein it allows checking whether the container 13 is empty. That is the case if the binary state information=“1” for the evaluation window 12.6.

Finally, the evaluation windows 12.7, 12.8 can be used to check whether the support for positioning the container 13, for example a conveying belt 15, is in the desired position. That is the case if the binary state information=“1” is respectively obtained for the evaluation windows 12.7 and 12.8. If the height position for the support changes, not enough object points are located in the evaluation windows 12.7, 12.8 and the binary state information=“0” is respectively obtained for the evaluation windows 12.7 and 12.8. The optical sensor 1 in that case advantageously generates a control signal for the follow-up of the other evaluation windows 12.1 to 12.6, so as to adapt their positions to the changed height of the support.

1-15. (canceled)

16. A method for optically detecting objects, comprising:
emitting light rays that are projected as a light line onto an object structure to be detected;
imaging the light rays on a matrix of receiving elements of a receiver and producing receiving element signals;
evaluating the receiving element signals with an evaluation by a triangulation principle to generate a distance profile, the evaluating including:
generating at least one evaluation window which encompasses a local range extending in a direction along the light line,
generating a number of object points representing outputs of the respective receiving element that correspond to respective distances extending in a second direction, and
generating a binary state information as a function of the number object points that fall within the evaluation window.

17. The method according to claim 16, wherein the step of generating the binary state information generating a first binary state information of “1” if the number of object points falling within the evaluation window is higher than a switch-on number and the binary state information generating a second binary state information of “0” if the number of object points in the evaluation window is lower than a switch-off number.

18. The method according to claim 17, further including adjusting the switch-on number and the switch-off number.

19. The method according to claim 16, wherein the step of generating at least one evaluation window includes generating a plurality of evaluation windows.

20. The method according to claim 19, wherein the step of generating the plurality of evaluation windows includes partially overlapping adjacent evaluation windows or arranging the adjacent evaluation windows at a distance to each other.

21. The method according to claim 19, wherein the step of generating the evaluation windows includes generating the evaluation windows with a variable number of positions and variable dimensions.

22. The method according to claim 16, wherein the evaluating further includes generating a control signal to cause a follow-up of the positions of the evaluation windows.

23. The method according to claim 19, wherein the evaluating further includes generating output variables based on a logical linking of the binary state information bits from individual evaluation windows.

24. The method according to claim 19, wherein the evaluating includes forming output variables from the binary state information bits from the evaluation windows.

25. The method according to claim 16, wherein the evaluating includes evaluating the individual object points within an evaluation window.

26. The method according to claim 16, wherein the evaluating includes evaluating only successively following object points within one evaluation window for determining object contours.

27. The method according to claim 16, wherein the evaluating includes evaluating amplitudes of signals received at the receiving elements to determine reflectance values for individual object points as additional information.

28. The method according to claim 16, wherein the evaluating includes evaluating a plurality of successively following measurements to generate a binary state information bit for an evaluation window.

29. The method according to claim 16, wherein the evaluating includes detects measuring value fluctuations within at least one evaluation and, in dependence thereon, generating an error message or a warning message.

30. The method according to claim 16, further including controlling exposure to light realized with the transmitter solely in dependence on the signals received at the receiving elements, which signals are located within the evaluation window or windows.
